(19) United States
(12) Patent Application Publication
(10) Pub. No.: US 2020/0387991 A1
(43) Pub. Date: Dec. 10, 2020

(54) Data management system for use with agreements and data detailng concepts, designs, and ideas

(71) Applicant: Natalie Anne Keleher Raffoul, Ottawa (CA)

(72) Inventor: Natalie Anne Keleher Raffoul, Ottawa (CA)

(21) Appl. No.: 16/894,494

(22) Filed: Jun. 5, 2020

Related U.S. Application Data
(60) Provisional application No. 62/857,724, filed on Jun. 5, 2019.

(51) Int. Cl. G06Q 50/18; G06Q 10/10; G06K 9/00; G06F 40/284

(52) U.S. Cl. CPC G06Q 50/184; G06F 40/284; G06K 9/00469; G06Q 10/10

(57) ABSTRACT

Systems and methods for managing an organization's agreements and possible IP assets. The system provides users from the organization a user interface in which to enter ideas, concepts, and/or designs from which IP assets may result. These entries can then be stored, managed, and mined as necessary by the organization. In addition, the system allows for the storage of the organization's agreements and for the analysis of such agreements to flag/identify potential issues with such agreements. Machine learning and artificial intelligence-based methods and subsystems can be used to analyze these agreements. Experts in the various relevant fields provide the logic and samples against which the agreements are to be assessed.

### RELATED APPLICATIONS

This is a non-provisional patent application which claims the benefit of U.S. provisional patent application No. 62/857,724 filed on Jun. 5, 2019.

### TECHNICAL FIELD

The present invention relates to data management. More specifically, the present invention relates to systems and methods for data management in organizations that generate agreements and intellectual property (IP).

### BACKGROUND

The innovation revolution of the late 20th and early 21st century has shown that intellectual property is valuable and can form one of the major assets for an organization. However, managing such IP has, previously, been seen as tedious and time consuming. In particular, managing the ideation process for new inventions, trademarks, and other IP developments is frequently handled manually—that is, by an individual or team at an organization trying to keep track of everything using spreadsheets, in-house document filing systems, and their memories. As IP assets get more complex, this process becomes extremely cumbersome. Important information, such as dates of first use or dates of disclosure, can be buried in lengthy email threads.

Additionally, early-stage ideation processes can be particularly difficult for unsophisticated IP generators. They may not know, e.g., details of filing processes, or disclosure requirements, or other important information that may affect their rights. Depending on their level of sophistication and/or funding, they may not seek advice on these issues until time limits have already expired. Accordingly, there would be a benefit to a system that can flag such issues to such users at the first stages of the ideation process.

Similarly, IP licensing agreements and other transactions involving IP are frequently organized by hand. This means that important details, such as renewal dates and specific restrictions, or specific language, may be easily forgotten. There would accordingly be a benefit to a system that can flag and compare such important details, and that can track changes between subsequent versions of agreements.

There are, currently, no systems or methods that allow for easy management of an organization's IP from the ideation stage through development, use, licensing, and (potentially) transfer. Various systems may permit some aspects of the IP management process to be handled electronically, but there is nothing that allows a holistic view of the entire process. There is, therefore, a need for such a system that does not require inordinate amounts of time to use and that does not significantly impinge on the time of employees to use.

### SUMMARY

The present invention provides systems and methods for managing an organization's agreements and possible IP assets. The system provides users from the organization a user interface in which to enter ideas, concepts, and/or designs from which IP assets may result. These entries can then be stored, managed, and mined as necessary by the organization. In addition, the system allows for the storage of the organization's agreements and for the analysis of such agreements to flag/identify potential issues with such agreements. Machine learning and artificial intelligence-based methods and subsystems can be used to analyze these agreements. Experts in the various relevant fields provide the logic and samples by which the agreements are assessed (either as a basis for a rules-based system or to train the artificial intelligence agents).

In a first aspect, this document discloses a system for managing intellectual property rights, said system comprising: a user interface configured to receive input from a user, wherein the information comprises at least one of a transaction document and a data file relating to an idea; a processor for receiving said input from said user interface, the processor comprising: an ideation module for providing information relating to an ideation process, wherein, when said input comprises said data file relating to an idea: said ideation module identifies at least one key word in said at least one data file, said at least one key word being added to said at least one data file by at least one user and said at least one key root word being identified based on predetermined trigger data in said at least one data file, wherein the at least one key word is either: at least a part of a trademark or a term that characterizes an invention based on the idea; and said ideation module causes said user interface to display intellectual property information relating to said at least one key word to said user, wherein said intellectual property information is retrieved from an intellectual property database that stores intellectual property information, a documentation analysis module for identifying at least one of: a risk in said transaction document and a change from a previous version of said transaction document, wherein, when said input comprises said transaction document: said documentation analysis module identifies at least one of: a presence of at least one transaction term in a document in the least one file, said at least one transaction term being a match with a term derived from at least one root word in a plurality of key root words, wherein each root word in said plurality is associated with transaction language used in transaction documentation or with a transaction risk that is a consequence of said transaction language; an absence of said at least one transaction term; and said change, and said documentation analysis module causes said user interface to display at least one of: preferred transaction language associated with said at least one transaction term; an indication of said transaction risk based on said presence or said absence of said at least one transaction term; and said change, and a database in communication with said processor, said database being for storing at least: said input; said plurality of key root words; and said at least one key word.

In a second aspect, this document discloses a system for identifying risk in documents comprising: a user interface for uploading at least one file associated with a transaction; a database for storing the least one file and for storing a plurality of key root words, wherein each key root word is associated with transaction language used in transaction documentation or with a transaction risk that is a consequence of said transaction language; a processor for identifying a presence of at least one transaction term in a document in the least one file, said at least one transaction term being a match with a term derived from at least one root word in said plurality of key root words; an absence of said at least one transaction term; and wherein said risk comprises legal risk or intellectual property related risk; said user interface displays preferred transaction language associated with said at least one transaction term whenever said at least one transaction term is identified by said processor in said document; said user interface provides an indication of said transaction risk when said at least one transaction term is identified in the document and when a use of said at least one transaction term in said document does not conform to said preferred transaction language.

In a third aspect, this document discloses a system for managing different versions of transaction documentation, the system comprising: a user interface for receiving and storing in a database a first transaction documentation file, a second transaction documentation file that is a subsequent version of the first transaction documentation file, and a third transaction documentation file, said first transaction documentation file and said second transaction documentation file both being related to a first transaction and said third transaction documentation file being related to a second transaction; a processor for identifying differences in documentation language between said first transaction documentation file and said second transaction documentation file such that documentation language that has been changed from said first transaction documentation file to result in documentation language in said second transaction documentation file is flagged as preferred documentation language; wherein documentation language flagged as preferred documentation language is stored in the database and is associated with a key root word, said preferred documentation language containing a transaction term that is derived from said key root word; and wherein the processor is further for identifying a specific transaction term in the third documentation transaction file and wherein, when said processor identifies said specific transaction term in said third documentation transaction file, the user interface displays at least one preferred documentation language associated with a specific key root word from which the specific transaction term has been derived; wherein said different versions of said transaction documents are used to train a model on preferred documentation language through changes made to documentation transaction files.

In a fourth aspect, this document discloses a system for managing data files relating to ideation, the system comprising: a user interface for receiving at least one data file associated with an idea, said at least one data file providing details regarding said idea; a first database for storing said at least one data file; a processor for identifying at least one key word in said at least one data file, said at least one key word being added to said at least one data file by at least one user and said at least one key root word being identified based on predetermined trigger data in said at least one data file, said at least one key word being related to said idea; a user interface for displaying said intellectual property information relating to said at least one key word, said intellectual property information being retrieved by a search engine based on said at least one key word; wherein the search engine searches and retrieves said intellectual property information from an external database that stores intellectual property information; wherein the at least one key word is either: part of a trademark or a term that characterizes an invention based on the idea.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the present invention,

FIG. 2 is a flowchart detailing a method according to an aspect of the invention,

FIG. 3 is a flowchart detailing a method according to an aspect of the invention, and

FIG. 4 is a flowchart detailing a method according to an aspect of the invention.

### DETAILED DESCRIPTION

The present invention provides systems and methods for managing data in an office environment. More specifically, the present invention is eminently suitable for a business or organization that generates intellectual property such as ideas, designs, copyrights, trademarks, and the like. Similarly, the system can also be used by organizations that handle or are involved in contracts, agreements, and other legal documents that involve intellectual property (IP).

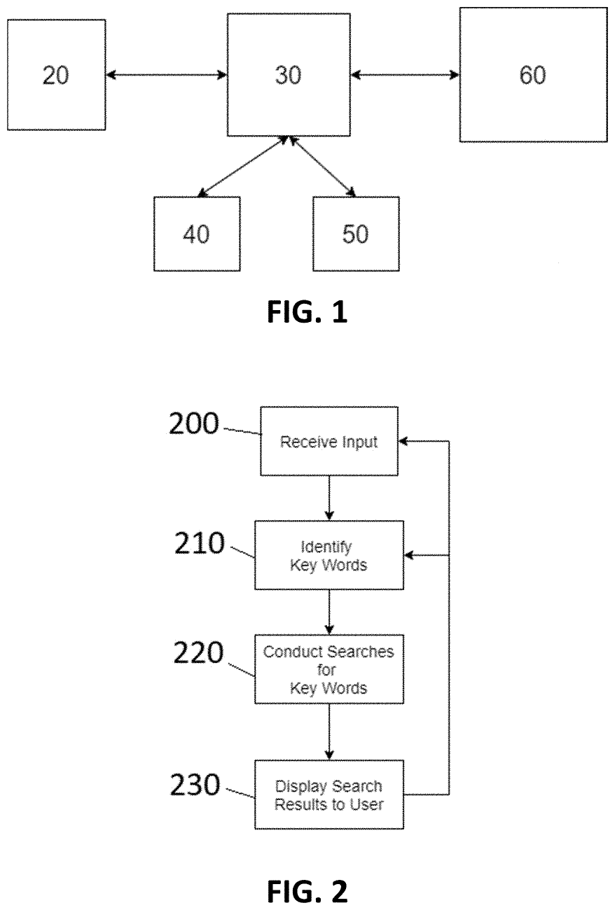

FIG. 1 shows a block diagram of the system 10 according to one aspect of the invention. System 10 comprises a user interface 20 in communication with a processor 30. The processor 30 comprises at least an ideation module 40 and a documentation analysis module 50. The processor 30 is in communication with a database 60, which stores input received by the user interface 20 as well as information processed by the processor 30, and which may store other related information as necessary. The input can include, without limitation, transaction documents and data files related to an idea or an ideation process.

In one implementation, the system uses a software agent that is deployed in one or more computer systems in the organization. In a preferable implementation, these agents can be called up/executed by every employee or contractor of the organization (i.e., a user). In some embodiments of the invention, user permissions may be restricted to a smaller group of people, or a single individual, depending on the organization's structure. This may be preferable for some organizations.

Once the software agent is called up, the user can enter ideas, concepts, designs, and other matters that may generate IP. These may be entered as direct text input and/or by uploading data files that can be processed by the system. These data files may include, without limitation, numeric data, text files, image files, video files, audio files, unidimensional data, and/or multi-dimensional data.

For ideas that may generate patentable inventions, the system provides the ability for every employee to enter invention disclosures through a quick guided series of directed questions and answers from the system. Again, to avoid the bottleneck of a single individual or team handling all such disclosures, providing this ability to each employee is often preferable.

The system has the ability to perform automated prior art searches based on the keywords entered by the user. The ideation module 40 may identify these keywords based on direct entry by the user, or by a user-added flag. Alternatively, in some implementations, the ideation module 40 may identify these keywords automatically. For instance, an AI model may be trained to identify the most significant words in a data file of a certain format or relating to a certain subject. Such an approach would simplify the work for the user. As the user enters these keywords or as the invention details are entered and keywords are identified, prior art searching begins in the background.

In some embodiments, these prior art searches are performed by automated/robotic agents that perform searches of the Internet (e.g., via Google™) and/or that search publicly available intellectual property databases provided by various national, regional, and/or international intellectual property offices. Additionally, in some embodiments, the user can specify which databases they wish to search. Further, in some embodiments, the system may provide a static link to such databases to allow the user to perform searches manually. Additionally, in certain embodiments, searching may be carried out in the organization's internal databases and/or records storage using plug-ins and/or agents.

The user interface 20 also allows for the real-time entry and updating of keywords, based on the entry of ideas, notes, and data files from the user. As these ideas and notes are entered, the prior art search may produce updated search results almost instantaneously. Accordingly, as ideation progresses, the prior art revealed from the searches can be changed on the fly, presenting the most relevant and/or valuable references while saving the user valuable time.

For other ideas and concepts that can be entered, product images or images of products by the organization can be loaded into the system's database. For products that cannot be imaged or pictured, or for products that can be protected by other forms of protection other than patents or trademarks, such other forms of registration can be suggested. For instance, the system 10 may recommend that the user consider seeking design registration or other forms of IP rights (e.g., plant breeder rights for a cannabis business). These other forms of IP may also include utility models in certain jurisdictions, and/or integrated circuit topography protections, among others.

As another capability for the system, in some embodiments, when images are submitted through the user interface 20, the user can produce black and white drawings from sketches and images. That is, in these embodiments, the processor 30 contains or links to an image-conversion module that allows images to be easily converted into line drawings suitable, or more suitable, for filing. This allows for the quick production of designs and concepts that can be sent to IP professionals. These IP professionals can then produce the requisite patent and/or design applications as necessary.

For contracts and other agreements, users can enter electronic copies of these agreements into the system. These can be added to the system's database 60. As examples, a user can enter all manner of contracts (e.g., employment, software license, sales or channel agreements) into the system. The system can then apply optical character recognition to convert the images of the agreements into computer-readable text and then the system can apply machine learning and/or artificial intelligence-based methods and subsystems to analyze the agreements. These methods and subsystems may include techniques related to natural language processing (NLP), using artificial intelligence models trained on legal documents by legal experts. Additionally, of course, optical character recognition may not be required as a separate step: for instance, contracts may be entered as text files that do not require special conversion. Alternatively, some artificial intelligence models may be able to combine character-recognition tasks and semantic parsing tasks, rather than requiring separate processes.

The documentation analysis module 50 can then flag IP risks and related legal risks, and cause the user interface 20 to notify the user of these risks. It should be clear that legal advice is never provided but that the system merely flags possible risks and provides relevant examples of such risks. Legal advice from a legal expert in the appropriate jurisdiction should still be obtained as (and if) the process moves forward. To this end, the user interface 20 can display warnings that indicate what legal advice will be required (e.g., what legal field or expertise may be required). To assist the user in understanding what has been flagged, sample agreements and clauses may be shown (with some explanations) to the user to indicate examples of the legal risks. The flags may be presented as, e.g., pop-ups, bubbles, notifications, or other warnings. Additionally, the flags may be output into a single file that could be easily printed or transmitted by the user.

Specifically, the documentation analysis module 50 analyzes the inputted documents against a plurality of key root words stored in the database 60. As should be understood, the key root words are words associated with transaction language and/or with transaction risks. The plurality of key root words may be updated by a legal expert on a regular basis and/or may be updated and developed by a trained AI model receiving legal feedback. As non-limiting examples, the key root words may include terms such as “warrant*” and “indemnif*” (wherein the asterisk is a wild-card, representing any possible character). Key root words can, of course, be full words that do not include wild-card symbols.

The documentation analysis module 50 then identifies a presence or an absence of at least one transaction term in the analyzed document. The at least one transaction term is a term that matches a term derived from at least one key root word in the plurality of key root words. For instance, using the examples above, a transaction term could include “warranty” or “indemnification”. The documentation analysis module 50 then prompts the user interface 20 to display preferred documentation language related to that transaction term. As an example, the user interface 20 may be prompted to display a preferred definition of “Invention” to the user.

The preferred documentation language is determined by legal experts in accordance with laws, regulations, case law, and best practices, and influenced by the organization's goals. Additionally, the user can select specific language that they prefer, preferably in consultation with legal advisors. Preferred documentation language can be stored in the database 60. In some cases, preferred documentation language may be based on the output of the ideation module 40, or the user input thereto. That is, in some embodiments, the ideation module 40 and the documentation analysis module 50 may be in direct communication with each other, and/or may use each other's outputs in making their recommendations to the user. For instance, the preferred documentation language for the description of a patented system that is to be licensed to a third party may be extracted from the original entry of a user at the ideation stage. Similarly, at the ideation stage, the ideation module 40 could flag potential issues with a potential invention that arise because of an agreement processed by the documentation analysis module 50. As should be clear, both the ideation module 40 and the documentation analysis module 50 can draw upon any suitable accessible resource as a basis for making recommendations.

Identifying an absence of a transaction term is more complex than identifying its presence. However, as more agreements are added to the database, or as the rules or AI model of the documentation analysis module 50 change, certain standard terms that should be included in legal agreements may be identified as key root words to look for. For instance, most agreements related to IP assets should contain some mention of Confidential Information. Accordingly, the documentation analysis module 50 may be directed to always look for the key root word “confidential*”, and to flag its absence to the user. This flag may be, e.g., a warning bubble or notification in the user interface 20 that notes the absence of an important term and provides suggested preferred language.

In some embodiments, the system 10 can also perform analysis of changes in transaction documents over time, and differences between documentation for different transactions. In such embodiments, the user inputs at least a first transaction documentation file and a second transaction documentation file that is a subsequent version of the first transaction documentation file. The first transaction documentation file and the second transaction documentation file in this embodiment are both related to a first transaction.

The documentation analysis module 50 can then identify differences in documentation language between the first transaction documentation file and the second transaction documentation file, again using rules- and/or AI-based techniques. As should be clear, AI and machine learning techniques such as legally trained NLP are preferable to hard-coded rules, as they allow the system to recognize slightly different phrases that have similar effects (and vice versa). That is, trained AI systems generally allow slightly more flexibility.

The differences between the first transaction documentation file and the second transaction documentation file are noted. In particular, the documentation analysis module 50 may record broad sections of the document that have changed, in addition to noting specific wording changes. For instance, indemnifications in a contract may go through several rounds of changes. The documentation analysis module 50 could note this as a high-level change (either by referring to subject headings in the document or by analyzing the context of each change, depending on the specific implementation of the module 50). Such high-level changes could be stored as metadata on the transaction documentation files or recorded in an easily accessible ‘notes’ file related to the overall transaction itself, and stored in the database 60.

Specific documentation language that has been changed to result in documentation language in the second transaction documentation file can then be flagged to become preferred documentation language for the associated key root word. This specific language can then also be stored in the database 60.

As should be noted, the most recent version of a document may not be the most favourable for the organization. Accordingly, the user may wish to flag language from the original version of the document to be preferred language. However, even some unfavourable changes may be useful: for instance, they may provide a compromise that was acceptable to both sides. Thus, in some embodiments, alternate preferred documentation language may be flagged by the user and stored in database 60 in association with a specific key root word or transaction term. In such embodiments, the user would be prompted to choose between multiple alternatives for the preferred language, depending on their goal (e.g., depending whether they wish to compromise or to reject the other party's proposal).

Of course, many further subsequent versions may be filed, and changes continually noted. The preferred language would be updated accordingly, so that the most recent language amended by the user would continually be preferred, unless the user selected other language to be preferred. In a preferred implementation, the different versions and different preferred language selections are used to train an AI model on preferred documentation language through changes made to documentation transaction files. The resulting AI model can then eventually be used to anticipate language that the user will prefer, rather than requiring the user to select alternative language.

In addition to the above, the system may also allow users to enter trademarks, brands, slogans, and designs into the database. These can then be used by the system to perform automated simple trademark searches. This allows potential issues with established or registered brands to be flagged. This may be handled by the ideation module 20 or, in some implementations, by separate trademarks and/or design ideation modules. In addition, dates of first use for various marks/designs can be tracked by the system and, for the user, the system can provide images or examples of how to mark products through the user interface 20.

One implementation of the present invention uses a smart database with logic-based rules built-in to determine generated outputs based on the inputs provided. As should be clear, however, such a rules-based system may struggle to provide sufficient flexibility as laws, practices, and the organization's goals and assets evolve. Accordingly, a system that is at least partially based on machine learning and artificial intelligence techniques and modules is generally preferable.

Such a system is configured to use machine learning and artificial intelligence to learn from training data sets which encapsulate relevant legal and patent advice in order to reduce risks. For example, AI may be used by the documentation analysis module 50 to identify more and more issues in contract reviews by continuously learning from a lawyer's feedback. For invention disclosures, the material provided by a user can be adjusted by the ideation module 40, using patent application templates, so that the end result will require less and less review by a patent agent. The system can thus learn, from patent applications in the same field, how to transform the user's ideas into at least something useful for patent professionals. Thus, as a patent portfolio increases in size, the system can learn more and more about how to convert a user's ideas into more useful product usable by patent professionals. This will reduce costs for the organization and should also reduce the time required to file a new patent application. On the agreements side, similar advantages can be had. As a company or organization enters more agreements into the database, and as the organization signs more patent licensing or sales agreements, the system learns to flag issues such that fewer inputs are required by a legal professional reviewing the agreements.

It should be clear that the database of the system will have a built-in expert system that takes into account the law in various jurisdictions. This allows for the analysis of agreements using, as governing law, the law in various jurisdictions. Again, this expert system may be completely or partially rules-based. However, the expert system is preferably used in conjunction with machine learning and artificial intelligence agents, and/or is at least partially based on machine learning and artificial intelligence techniques, to more effectively flag possible issues in different jurisdictions. As an example, experts (e.g., lawyers, patent agents, trademark agents, etc.) in the relevant fields of law (e.g., IP, contracts, employment law) in various jurisdictions could provide the logic/expertise by which to assess the organization's agreements in the database. This may be provided as rules to be directly implemented, or as data to be used in a training process in order to train an AI-based module to evaluate such agreements. Thus, in the example, the system may be suitable for analyzing agreements for possible issues relating to the relevant laws and rules in Delaware, New York, California, Illinois, Ontario, Quebec, BC, Florida, UK, etc.

As should be clear from the above, a system using such AI approaches would be able to tailor its recommendations to the goals and purposes of the organization, as well as to changes in laws, regulations, and best practices. However, again, even with such adaptations, this system does not provide legal advice.

In some implementations, the system 10 may provide links and/or contact information to speak with or contact IP experts, such as patent/trademark agents and/or IP lawyers. This information may include, e.g., expedited email forms, phone numbers, and/or chat windows. Additionally, the user interface 20 may provide links to databases or webpages listing such experts.

The system 10 may also include basic resources stored in the database 60 and accessible through the user interface 20. These may include Frequently Asked Questions documents, copies of legal notices, and other relevant information.

The system 10 may use a notepad that may be implemented by way of a notepad module that is accessible through the user interface 20. The notepad module when activated provides the user with a blank workspace where the user can add text, graphics or drawings, as well as links to various websites. In some embodiments, the user can also drag and drop video and/or audio into the notepad. The notepad module may also have formatting capabilities.

Additionally, in some embodiments, the system 10 may provide a budgeting module or widget that allows the user to forecast how much certain IP protection strategies would cost.

In one implementation, the system and its related database may be hosted at the organization's premises/servers, or a server at a remote location or locations. Alternatively, the system may be hosted in a cloud-based server and users/organizations can access the system using a software-as-a-service subscription based model. Different constraints and/or user requirements may determine how the system is provided: for instance, an organization with significant in-house processing power may prefer a downloadable version of the system.

The user may also access the system services using multiple forms of computer or data processing devices. As examples, the system may provide its agents on the user's mobile or desktop devices. Desktop and mobile applications can be used to ensure that content by users can be easily uploaded. Other forms of access may be provided, depending on the available technology.

Similarly, it should be clear that the database(s) provided by this system may store data in any suitable fashion. For instance, the data may be stored directly on-site, in the cloud, or on a remote server. Further, in some embodiments, plug-ins or interface agents may allow the system to access data in the organization's pre-existing or third-party databases. With such access, the user might not need to directly enter specific information to the system. Rather, the system could scan or process any documents in the organization's database to flag potential issues. Additionally, as should be clear, any document, file, or other data stored in the database 60 is available to any module of the system 10 for any suitable purpose, e.g., any such document may be used by the ideation module when searching.

FIG. 2 is a flowchart detailing a method according to an aspect of the invention. Specifically, FIG. 2 details a method when input relating to an idea is received (step 200). Keywords are identified at step 210, either directly by the user or by the ideation module of the system. Searches based on those keywords are then performed at step 220. The results of the searches are displayed to the user at step 230. As should be clear, searching is an iterative process and the user may choose to add additional information or identify new key words after viewing the results, thus returning to an earlier step.

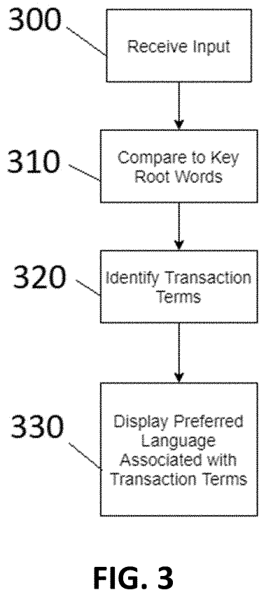

FIG. 3 is another flowchart detailing a method according to the present invention. Specifically, FIG. 3 details a method when a transaction document, such as a contract, is received (step 300). At step 310, the document is analyzed and compared to a plurality of key root words. Transaction term(s) related to key root word(s) within that document are identified at step 320. Then, at step 330, preferred language associated with the transaction term(s) and/or the key root word(s) is displayed to the user through the user interface.

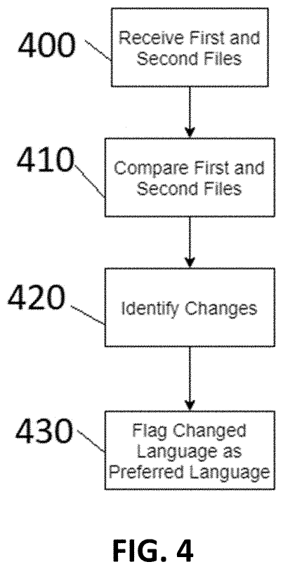

FIG. 4 is another flowchart detailing a method according to the present invention. Specifically, FIG. 4 details a method when two versions of a transaction document, such as a contract, are received (step 400). At step 410, the first and second versions of the files are compared to each other, and changes related to transaction terms and/or key root words are identified at step 420. The changed language (i.e., the language in the second version of the file) is flagged as preferred language at step 430. That language may then be displayed to a user.

As should be clear, the single system of the present invention is capable of performing each of these methods.

Note that the phrase “at least one of [x] and [y]”, as used herein, should be construed as meaning “[x], [y], or both [x] and [y]”. Further, any references herein to singular modules or units should be construed as encompassing the plural form.

In another aspect, the present invention provides a system for managing intellectual property rights, said system comprising:

a user interface configured to receive input from a user, wherein the information comprises at least one of a transaction document and a data file relating to an idea;
a processor for receiving said input from said user interface, the processor comprising:
an ideation module for providing information relating to an ideation process, wherein, when said input comprises said data file relating to an idea:
   said ideation module identifies at least one key word in said at least one data file, said at least one key word being added to said at least one data file by at least one user and said at least one key root word being identified based on predetermined trigger data in said at least one data file, wherein the at least one key word is either: at least a part of a trademark or a term that characterizes an invention based on the idea; and
   said ideation module causes said user interface to display intellectual property information relating to said at least one key word to said user, wherein said intellectual property information is retrieved from an intellectual property database that stores intellectual property information,
a documentation analysis module for identifying at least one of: a risk in said transaction document and a change from a previous version of said transaction document, wherein, when said input comprises said transaction document:
   said documentation analysis module identifies at least one of: a presence of at least one transaction term in a document in the least one file, said at least one transaction term being a match with a term derived from at least one root word in a plurality of key root words, wherein each root word in said plurality is associated with transaction language used in transaction documentation or with a transaction risk that is a consequence of said transaction language; an absence of said at least one transaction term; and said change, and
   said documentation analysis module causes said user interface to display at least one of: preferred transaction language associated with said at least one transaction term; an indication of said transaction risk based on said presence or said absence of said at least one transaction term; and said change, and
      a database in communication with said processor, said database being for storing at least: said input; said plurality of key root words; and said at least one key word;
      wherein said input comprises a first transaction documentation file a second transaction documentation file and wherein:
      said documentation analysis module identifies at least one change in language between said first transaction documentation file and said second transaction documentation file, wherein said at least one change is related to at least one specific key root word; and
      changed language in said second transaction documentation file that is related to said at least one change is flagged as specific preferred language to be associated with said at least one specific key root word; and
      wherein said input further comprises a third transaction documentation file and wherein, when said documentation analysis module identifies a presence or an absence of said specific preferred language in said third transaction documentation file, said documentation analysis module causes said user interface to present said specific preferred language to said user; and
      wherein said second transaction documentation file is a later version of said first transaction documentation file.

It should be clear that the various aspects of the present invention may be implemented as software modules in an overall software system. As such, the present invention may thus take the form of computer executable instructions that, when executed, implements various software modules with predefined functions.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for identifying risk in documents, the system comprising:
a user interface for uploading at least one file associated with a transaction;
a database for storing the least one file and for storing a plurality of key root words, wherein each key root word is associated with transaction language used in transaction documentation or with a transaction risk that is a consequence of said transaction language;
a processor for identifying at least one of:
a presence of at least one transaction term in a document in the least one file, said at least one transaction term being a match with a term derived from at least one root word in said plurality of key root words; and
an absence of said at least one transaction term;
wherein:
said risk comprises legal risk or intellectual property related risk;
said user interface displays preferred transaction language associated with said at least one transaction term whenever said at least one transaction term is identified by said processor in said document; and
said user interface provides an indication of said transaction risk when said at least one transaction term is identified in the document and when a use of said at least one transaction term in said document does not conform to said preferred transaction language.

2. A system according to claim 1, wherein each key root word is associated with at least one other word such that said key root word and said at least one other word forms a key phrase, each key phrase being associated with at least one specific preferred transaction language.

3. A system for managing different versions of transaction documentation, the system comprising:
a user interface for receiving and storing in a database a first transaction documentation file, a second transaction documentation file that is a subsequent version of the first transaction documentation file, and a third transaction documentation file, said first transaction documentation file and said second transaction documentation file both being related to a first transaction and said third transaction documentation file being related to a second transaction;
a processor for identifying differences in documentation language between said first transaction documentation file and said second transaction documentation file such that documentation language that has been changed from said first transaction documentation file to result in documentation language in said second transaction documentation file is flagged as preferred documentation language;
wherein documentation language flagged as preferred documentation language is stored in the database and is associated with a key root word, said preferred documentation language containing a transaction term that is derived from said key root word; and

4. The system according to claim 3, wherein the processor is further for identifying a specific transaction term in the third documentation transaction file and
wherein, when said processor identifies said specific transaction term in said third documentation transaction file, the user interface displays at least one preferred documentation language associated with a specific key root word from which the specific transaction term has been derived;
wherein said different versions of said transaction documents are used to train a model on preferred documentation language through changes made to documentation transaction files.

5. The system according to claim 3, wherein the processor automatically identifies changes between subsequent versions of said transaction documentation files.

6. The system according to claim 3, wherein the processor identifies a context for said specific transaction term in said third transaction documentation file and said user interface displays a single preferred documentation language associated with said specific key root word, said single preferred documentation language being calculated by said processor to be most suitable for said context.

7. A system for managing data files relating to ideation, the system comprising:
a user interface for receiving at least one data file associated with an idea, said at least one data file providing details regarding said idea;
a first database for storing said at least one data file;
a processor for identifying at least one key word in said at least one data file, said at least one key word being added to said at least one data file by at least one user and said at least one key root word being identified based on predetermined trigger data in said at least one data file, said at least one key word being related to said idea; and
a user interface for displaying said intellectual property information relating to said at least one key word, said intellectual property information being retrieved by a search engine based on said at least one key word,
wherein the search engine searches and retrieves said intellectual property information from an external database that stores intellectual property information, and
wherein the at least one key word is either:
at least a part of a trademark or
a term that characterizes an invention based on the idea.
